(19) United States
(12) Patent Application Publication
(10) Pub. No.: US 2005/0130497 A1
(43) Pub. Date: Jun. 16, 2005

(54) Stress dispersing lead and stress dispersing method of lead

(76) Inventors: Yoshihiro Asakura, Tokyo (JP); Kenya Kamijo, Tokyo (JP); Akihiro Nakanishi, Tokyo (JP); Toshihiko Watanabe, Tokyo (JP); Toru Aihara, Tokyo (JP)

Correspondence Address: YOUNG & THOMPSON, 745 SOUTH 23RD STREET, 2ND FLOOR, ARLINGTON, VA, 22202, US

(21) Appl. No.: 10/990,380

(22) Filed: Nov. 18, 2004

(30) Foreign Application Priority Data
Nov. 18, 2003 (JP) 388158/2003

(51) Int. Cl. H01J 1/00

(52) U.S. Cl. 439/615

(57) ABSTRACT

On a printed circuit board, there are mounted a pair of first leads, a first semiconductor device mounted on each of the first leads, a pair of second leads, and a second semiconductor device mounted on each of the second leads. A semiconductor device connecting terminal portion of each of the first leads extends to an outer side from the first semiconductor device, and one end of an intermediate slope portion of each of the first leads is bent to an inner side, whereby a substrate connecting terminal portion is structured. Accordingly, since an entire length of each of the first leads is elongated, a stress is absorbed dispersedly, and a tape carrier package is made compact.

### BACKGROUND OF THE INVENTION

The present invention relates to a lead to which a stress in a tape carrier package is dispersed, and a method of dispersing a stress generated in the lead.

A description will be given of a relevant structure of a lead and a printed circuit board in a conventional tape carrier package with reference to FIGS. 1A and 1B. FIG. 1A is a cross sectional view of a whole structure, and FIG. 1B is an enlarged cross sectional view of a portion within an oval in FIG. 1A. A structure within a broken line oval in FIG. 1B shows a main portion of the lead.

As shown in FIG. 1B, electrodes 22a provided in both right and left sides of a semiconductor device 22 such as an IC chip or the like are connected onto semiconductor device connecting terminal portions 21a of a pair of small leads 21 arranged in a lower side, respectively. A leading end of an intermediate slope portion 21b of each of the leads 21 is bent to an outer side, whereby a substrate connecting terminal portion 21c is structured.

Electrodes 24a provided in both right and left sides of a semiconductor device 24 are connected onto semiconductor device connecting terminal portions 23a of a pair of large leads 23 arranged in an upper side, respectively. A leading end of an intermediate slope portion 23b of each of the leads 23 is bent to an outer side, whereby a substrate connecting terminal portion 23c is structured.

The substrate connecting terminal portion 21c of each of the leads 21 and the substrate connecting terminal portion 23c of each of the leads 23 are connected by solder to pads 25a of a printed circuit board 25, respectively.

An upper surface of the semiconductor device 24 is in contact with a silicone sheet 27 which is attached to a copper cover 26. A heat radiation is executed from an inner side of the tape carrier package to an outer side thereof by the means mentioned above.

A structure and a function of a lower half portion of the tape carrier package are the same as the structure and the function of an upper half portion.

A length of the lower lead 21 is short. Since the length of the lead is bounded by a width of the tape carrier package and a thickness of a module, it is estimated that the length is going to be further shorter. If the length of the lead is short, the lead can not absorb a repeated bending stress generated at a time of a temperature cycle. Accordingly, the lead is ruptured.

In this case, there has been proposed a structure for preventing an excessive stress from being generated in a connection portion of a bump and an inner lead, by arranging an R-bent portion depressed to a side of the semiconductor device in the inner lead connected to the bump formed on the semiconductor device, in the taper carrier package on which the semiconductor is mounted (for example, refer to JP-A-11-40622).

Further, there has been proposed a structure for lowering a stress generated by a base film applied to an inner lead so as to prevent the inner lead from being ruptured, by supporting the inner lead suspending an IC chip by a stress relaxation portion of a base film, and elastically deforming the stress relaxation portion (for example, refer to JP-A-10-178052).

Since the conventional lead can not absorb the repeated bending stress generated at a time of the temperature cycle due to its short length, the lead is ruptured.

### SUMMARY OF THE INVENTION

An object of the present invention is to provide a lead which can absorb a repeated bending stress generated at a time of a temperature cycle, and a stress treating method of the same.

The object can be achieved by the following stress dispersing lead and lead stress dispersing method.

1. A stress dispersing lead in which a lead is continuously and integrally structured by a semiconductor device connecting terminal portion, an intermediate slope portion and a substrate connecting terminal portion, the semiconductor device connecting terminal portion extends to an outer side from a semiconductor device, and the substrate connecting terminal portion is bent to an inner side from one end of the intermediate slope portion.

2. A stress dispersing lead in which a lead is continuously and integrally structured by a semiconductor device connecting terminal portion, an intermediate slope portion and a substrate connecting terminal portion, a semiconductor device is arranged between the semiconductor device connecting terminal portion and a substrate, and an electrode of the semiconductor device is connected to the semiconductor device connecting terminal portion.

3. A stress dispersing lead in which a lead is continuously and integrally structured by a semiconductor device connecting terminal portion, an intermediate slope portion and a substrate connecting terminal portion, a semiconductor device is provided with an electrode near a center thereof, and the semiconductor device connecting terminal portion is connected to the electrode.

4. A stress dispersing lead in which a lead is continuously and integrally structured by a semiconductor device connecting terminal portion, an intermediate slope portion and a substrate connecting terminal portion, the semiconductor device connecting terminal portion, the intermediate slope portion and the substrate connecting terminal portion are formed approximately in an S-shape as a whole.

### BRIEF DESCRIPTION OF THE DRAWINGS

FIG. 1A is a cross sectional view of a whole of a lead in a conventional tape carrier package;

FIG. 1B is an enlarged cross sectional view of a part surrounded by an oval in FIG. 1A;

FIG. 2 is a cross sectional view of an embodiment 1 of a stress dispersing lead in a taper carrier package and a method of dispersing a stress of a lead in accordance with the present invention;

FIG. 3 is a cross sectional view of an embodiment 2 in accordance with the present invention;

FIG. 4 is a cross sectional view of an embodiment 3 in accordance with the present invention; and

FIG. 5 is a cross sectional view of an embodiment 4 in accordance with the present invention.

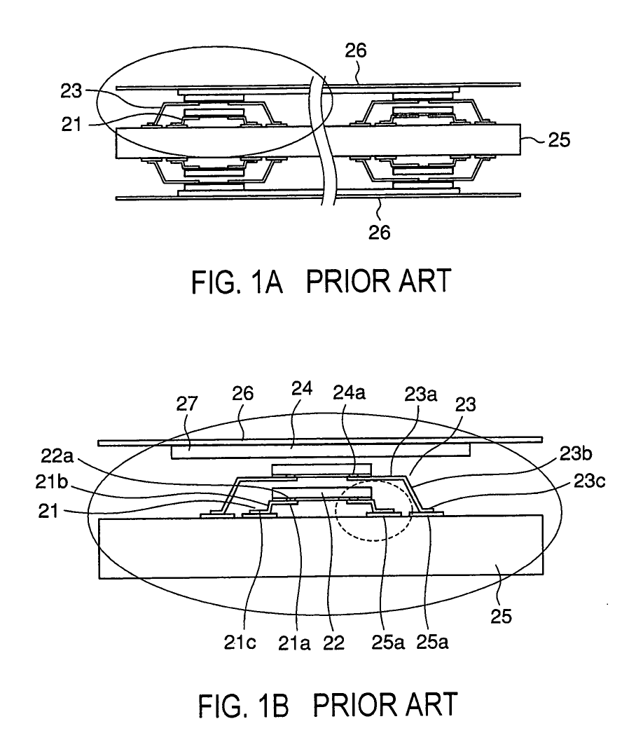

### DESCRIPTION OF THE PREFERRED EMBODIMENT

A description will be given of a stress dispersing lead and a lead stress dispersing method in accordance with four embodiments of the present invention.

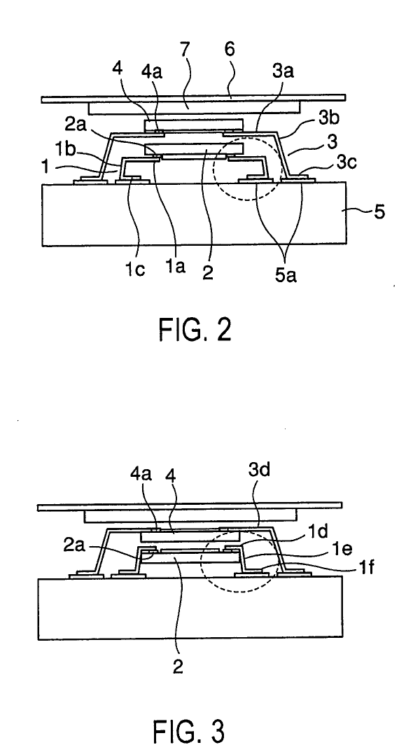

A description will be given of an embodiment 1 in accordance with the present invention with reference to FIG. 2.

FIG. 2 is a cross sectional view of a whole of a relevant structure of a lead and a printed circuit board in a tape carrier package, and a structure within a broken oval corresponds to a main portion of the lead.

Electrodes 2a provided in both right and left sides of a semiconductor device 2 such as an IC chip or the like are connected onto semiconductor device connecting terminal portions 1a of a pair of small leads 1 arranged in a lower side, respectively. The semiconductor connecting terminal portion 1a of each of the leads 1 extends to an outer side from the semiconductor device 2. One end of an intermediate slope portion 1b of each of the leads 1 is bent to an inner side, whereby a substrate connecting terminal portion 1c is structured.

Electrodes 4a provided in both right and left sides of a semiconductor device 4 are connected onto semiconductor device connecting terminal portions 3a of a pair of large leads 3 arranged in an upper side, respectively. One end of an intermediate slope portion 3b of each of the leads 3 is bent to an outer side, whereby a substrate connecting terminal portion 3c is structured.

The substrate connecting terminal portion 1c of each of the leads 1 and the substrate connecting terminal portion 3c of each of the leads 3 are connected by solder to pads 5a of a printed circuit board 5, respectively.

An upper surface of the semiconductor device 4 is in contact with a silicone sheet 7 which is attached to a copper cover 6. In this case, a portion between the semiconductor device 4 and the silicone sheet 7 is shown in a spaced manner in the drawing. A heat radiation is executed from an inner side of the tape carrier package to an outer portion by the means mentioned above.

In the embodiment 1, the semiconductor device connecting terminal portion 1a of the lead 1 extends to the outer side from the semiconductor device 2, and the one end of the intermediate slope portion 1b of the lead 1 is bent to the inner side, whereby the substrate connecting terminal portion 1c is structured. Accordingly, since an entire length of the lead 1 is elongated, the stress is absorbed dispersedly, and the tape carrier package is made compact.

A description will be given of an embodiment 2 in accordance with the present invention with reference to FIG. 3.

In the description of the embodiments 2 to 4, a description of the same points as those of the embodiment 1 is omitted and is given only of different points.

An intermediate slope portion 1e in accordance with the embodiment 2 is structured by extending the intermediate slope portion 1b in the embodiment 1. Electrodes 2a provided in both right and left sides of the reversed semiconductor device 2 are connected to a lower side of a semiconductor device connecting portion id, respectively. The semiconductor device connecting terminal portion 1d may be changed in design such that the semiconductor device connecting terminal portion 1d does not extend to the outer side from the semiconductor device 2. Further, a substrate connecting terminal portion 1f may be structured by bending one end of the intermediate slope portion 1e to the outer side.

The electrodes 4a provided in both right and left sides of the reversed semiconductor device 4 are connected to a lower side of the semiconductor device connecting terminal portion 3d, respectively.

In the embodiment 2, an entire length of the lead 1 is elongated by extending the intermediate connecting portion 1e and connecting the electrodes 2a provided in both right and left sides of the reversed semiconductor device 2 to the lower side of the semiconductor device connecting terminal portion 1d.

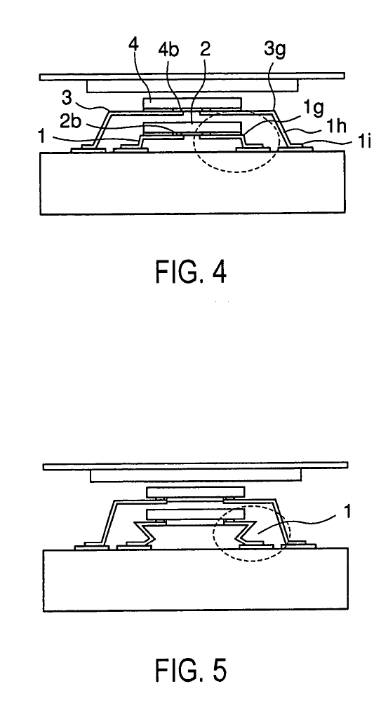

A description will be given of an embodiment 3 in accordance with the present invention with reference to FIG. 4.

Each of the electrodes 2a and 4a in accordance with the embodiment 1 are provided in both right and left sides of the semiconductor devices 2 and 4, respectively, however, electrodes 2b and 4b in accordance with the embodiment 3 are provided near center portions of the semiconductor devices 2 and 4, respectively. Lengths of semiconductor device connecting terminal portions 1g and 3g of the leads 1 and 3 are structured long in correspondence to arrangements of the respective electrodes 2b and 4b. The semiconductor device connecting terminal portion 1g may be changed in design such that the semiconductor device connecting terminal portion does not extend to the outer side from the semiconductor device 2. Further, a substrate connecting terminal portion 1i is structured by bending one end of an intermediate slope portion 1h to an outer side.

In the embodiment 3, an entire length of the lead 1 is elongated on the basis of the structure of the leads 1 and 3 and the semiconductor devices 2 and 4 mentioned above.

A description will be given of an embodiment 4 in accordance with the present invention with reference to FIG. 5.

The lead 1 in accordance with the embodiment 4 is structured by modifying a whole of the lead 1 constituted by the semiconductor device connecting terminal portion 1a, the intermediate slope portion 1b and the substrate connecting terminal portion 1c in accordance with the embodiment 1, in an approximately S shape.

In the embodiment 4, an entire length of the lead 1 is elongated by a simple structure in which the lead 1 is simply curved at two times.

As is apparent from the description in the specification, the following effects can be achieved by the present invention.

1. Since the entire length of the lead is elongated, the stress is absorbed dispersedly, and the tape carrier package is made compact.

2. It is possible to elongate the entire length of the lead by simply modifying the lead, changing the attitude of the semiconductor device, and changing the arrangement of the electrode in the semiconductor device.

1. A stress dispersing lead, wherein a lead is continuously and integrally structured by a semiconductor device connecting terminal portion, an intermediate slope portion and a substrate connecting terminal portion, said semiconductor device connecting terminal portion extends to an outer side from a semiconductor device, and said substrate connecting terminal portion is bent to an inner side from one end of said intermediate slope portion.

2. A stress dispersing lead, wherein a lead is continuously and integrally structured by a semiconductor device connecting terminal portion, an intermediate slope portion and a substrate connecting terminal portion, a semiconductor device is arranged between said semiconductor device connecting terminal portion and a substrate, and an electrode of said semiconductor device is connected to said semiconductor device connecting terminal portion.

3. A stress dispersing lead, wherein a lead is continuously and integrally structured by a semiconductor device connecting terminal portion, an intermediate slope portion and a substrate connecting terminal portion, a semiconductor device is provided with an electrode near a center thereof, and said semiconductor device connecting terminal portion is connected to said electrode.

4. A stress dispersing lead, wherein a lead is continuously and integrally structured by a semiconductor device connecting terminal portion, an intermediate slope portion and a substrate connecting terminal portion, said semiconductor device connecting terminal portion, said intermediate slope portion and said substrate connecting terminal portion are formed approximately in an S-shape as a whole.
